(19) United States
(12) Patent Application Publication
(10) Pub. No.: US 2025/0306215 A1
(43) Pub. Date: Oct. 2, 2025

(54) Satellite-Based Navigation And Positioning System Interference Mitigated Reradiation

(71) Applicant: GPS Networking, Inc., Pueblo West, CO (US)

(72) Inventors: Ryan Waite, Pueblo West, CO (US); Alan Whitfield, Lymington (GB); Anne Cortez, Kennebunkport, ME (US)

(21) Appl. No.: 18/619,817

(22) Filed: Mar. 28, 2024

(51) Int. Cl. G01S 19/31; G01S 19/25

(52) U.S. Cl. CPC G01S 19/31; G01S 19/258

(57) ABSTRACT

A satellite-based navigation and positioning system reradiation system includes an unobstructed satellite-based navigation and positioning system receiver that continuously receives satellite-based navigation and positioning system signals from a satellite-based navigation and positioning system constellation and a satellite-based navigation and positioning system re-radiator operatively coupled with the satellite-based navigation and positioning unobstructed system receiver and configured in a location that is obstructed with respect to the satellite-based navigation and positioning system signals transmitted by the satellite-based navigation and positioning system constellation that obtains satellite-based navigation and positioning system signals from the unobstructed satellite-based navigation and positioning system receiver and reradiates the satellite-based navigation and positioning system signals in accordance with a defined minimal time controlled reradiation schedule.

### TECHNICAL FIELD

This disclosure relates to satellite-based navigation and positioning systems.

### BACKGROUND

Satellite, or space vehicle, based navigation and positioning systems, such as the Global Positioning System (GPS), include satellites (space segment) orbiting Earth that continuously transmit (broadcast) signals, including precise positioning data, timing data, or a both, to terrestrial receivers (user segment). The terrestrial receivers receive the Global Positioning System signals sent by the Global Positioning System satellites and use the received signals to synchronize temporal (clock) data, determine precise geographic locations, including latitude, longitude, and altitude, of the terrestrial receivers, or both.

### SUMMARY

Disclosed herein are implementations of satellite-based navigation and positioning system interference mitigated reradiation.

An aspect of the disclosure is a method of satellite-based navigation and positioning system interference mitigated reradiation. Satellite-based navigation and positioning system interference mitigated reradiation may include operating a first satellite-based navigation and positioning system receiver having an unobstructed signal path with respect to at least one satellite-based navigation and positioning system satellite from a constellation of satellite-based navigation and positioning system satellites. Satellite-based navigation and positioning system interference mitigated reradiation may include operating, in accordance with a minimal time controlled reradiation schedule, at least one satellite-based navigation and positioning system re-radiator operatively coupled with the first satellite-based navigation and positioning system receiver via a wireline electronic communication medium, wherein the satellite-based navigation and positioning system re-radiator includes a satellite-based navigation and positioning system re-radiating antenna. Operating the at least one satellite-based navigation and positioning system re-radiator in accordance with the minimal time controlled reradiation schedule may include automatically preventing the at least one satellite-based navigation and positioning system re-radiator from reradiating satellite-based navigation and positioning system signals at temporal locations other than temporal locations in one or more reradiation windows defined by the minimal time controlled reradiation schedule. Operating the at least one satellite-based navigation and positioning system re-radiator in accordance with the minimal time controlled reradiation schedule may include automatically operating the at least one satellite-based navigation and positioning system re-radiator to reradiate satellite-based navigation and positioning system signals obtained from the first satellite-based navigation and positioning system receiver at temporal locations in the one or more reradiation windows defined by the minimal time controlled reradiation schedule to zero or more second satellite-based navigation and positioning system receivers, wherein the zero or more second satellite-based navigation and positioning system receivers are spatially located within the vehicle bay such that the zero or more second satellite-based navigation and positioning system receivers are obstructed from otherwise receiving the satellite-based navigation and positioning system signals transmitted by the constellation of satellite-based navigation and positioning system satellites.

An aspect of the disclosure is a satellite-based navigation and positioning system re-radiation system. The satellite-based navigation and positioning system re-radiation system may include a first satellite-based navigation and positioning system receiver having an unobstructed signal path with respect to at least one satellite-based navigation and positioning system satellite from a constellation of satellite-based navigation and positioning system satellites. The satellite-based navigation and positioning system re-radiation system may include a satellite-based navigation and positioning system re-radiator operatively coupled with the first satellite-based navigation and positioning system receiver via a wireline electronic communication medium, wherein the satellite-based navigation and positioning system re-radiator includes a satellite-based navigation and positioning system re-radiating antenna, wherein the satellite-based navigation and positioning system re-radiator includes a microcontroller configured to control the satellite-based navigation and positioning system re-radiator in accordance with a minimal time controlled reradiation schedule, wherein to control the satellite-based navigation and positioning system re-radiator in accordance with the minimal time controlled reradiation schedule. The microcontroller may control the satellite-based navigation and positioning system re-radiator to omit reradiating satellite-based navigation and positioning system signals at temporal locations other than temporal locations in one or more reradiation windows defined by the minimal time controlled reradiation schedule. The microcontroller may control the satellite-based navigation and positioning system re-radiator to reradiate satellite-based navigation and positioning system signals obtained from the first satellite-based navigation and positioning system receiver at temporal locations in the one or more reradiation windows defined by the minimal time controlled reradiation schedule to zero or more second satellite-based navigation and positioning system receivers, wherein the zero or more second satellite-based navigation and positioning system receivers are spatially located within the vehicle bay such that the zero or more second satellite-based navigation and positioning system receivers are obstructed from otherwise receiving the satellite-based navigation and positioning system signals transmitted by the constellation of satellite-based navigation and positioning system satellites.

An aspect of the disclosure is a non-transitory computer-readable storage medium, comprising executable instructions that, when executed by a processor, facilitate performance of operations, comprising satellite-based navigation and positioning system interference mitigated reradiation. Satellite-based navigation and positioning system interference mitigated reradiation may include operating a first satellite-based navigation and positioning system receiver having an unobstructed signal path with respect to at least one satellite-based navigation and positioning system satellite from a constellation of satellite-based navigation and positioning system satellites. Satellite-based navigation and positioning system interference mitigated reradiation may include operating, in accordance with a minimal time controlled reradiation schedule, at least one satellite-based navigation and positioning system re-radiator operatively coupled with the first satellite-based navigation and positioning system receiver via a wireline electronic communication medium, wherein the satellite-based navigation and positioning system re-radiator includes a satellite-based navigation and positioning system re-radiating antenna. Operating the at least one satellite-based navigation and positioning system re-radiator in accordance with the minimal time controlled reradiation schedule may include automatically preventing the at least one satellite-based navigation and positioning system re-radiator from reradiating satellite-based navigation and positioning system signals at temporal locations other than temporal locations in one or more reradiation windows defined by the minimal time controlled reradiation schedule. Operating the at least one satellite-based navigation and positioning system re-radiator in accordance with the minimal time controlled reradiation schedule may include automatically operating the at least one satellite-based navigation and positioning system re-radiator to reradiate satellite-based navigation and positioning system signals obtained from the first satellite-based navigation and positioning system receiver at temporal locations in the one or more reradiation windows defined by the minimal time controlled reradiation schedule to zero or more second satellite-based navigation and positioning system receivers, wherein the zero or more second satellite-based navigation and positioning system receivers are spatially located within the vehicle bay such that the zero or more second satellite-based navigation and positioning system receivers are obstructed from otherwise receiving the satellite-based navigation and positioning system signals transmitted by the constellation of satellite-based navigation and positioning system satellites.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of a computing and communication device.

FIG. 2 is a diagram of an example of a satellite-based navigation and positioning system.

FIG. 3 is a diagram of an example of a satellite-based navigation and positioning system with interference mitigated reradiation.

FIG. 4 is a diagram of an example of signal analysis with respect to the Global Positioning System first signal frequency.

FIG. 5 is a diagram of an example of signal analysis with respect to the Global Positioning System second signal frequency.

### DETAILED DESCRIPTION

Satellite-based navigation and positioning systems, such as the Global Positioning System (GPS), include satellites, such as a constellation of satellites, orbiting Earth that continuously transmit (broadcast) signals, including precise positioning data, timing data, or a both, to terrestrial receivers. The terrestrial receivers, on or near the surface of Earth, receive the satellite-based navigation and positioning system signals sent by the satellite-based navigation and positioning system satellites and use the received signals to synchronize temporal (clock) data, determine precise geographic locations of the terrestrial receivers (trilateration), determine velocities of the terrestrial receivers, perform navigation, or a combination thereof.

For vehicles used in time critical situations, such as emergency response vehicles, such as a firetruck, an ambulance, a police car, or the like, minimizing the time to scene, which is the temporal difference between the temporal location of a request, or call, for emergency response to the temporal location that the emergency response vehicle arrives at the destination or scene, preserves life and property and improves public safety. Similarly, for time critical systems, such as emergency response systems, minimizing the time to locate, track, or both, respective emergency response vehicles preserves life and property and improves public safety. To minimize the time to scene, the time to locate, or both, emergency response vehicles incorporate terrestrial satellite-based navigation and positioning system receivers and use satellite-based navigation and positioning system information obtained by the terrestrial receivers to perform geolocation and navigation.

The satellite-based navigation and positioning system interference mitigated reradiation described herein improves the minimization of time to scene, the time to locate, or both, for emergency response vehicles housed in satellite-based navigation and positioning system signal occluded environments while minimizing external signal interference by operating shielded, directed, passive, indoor satellite-based navigation and positioning system signal re-radiators in accordance with a limited intermittent schedule.

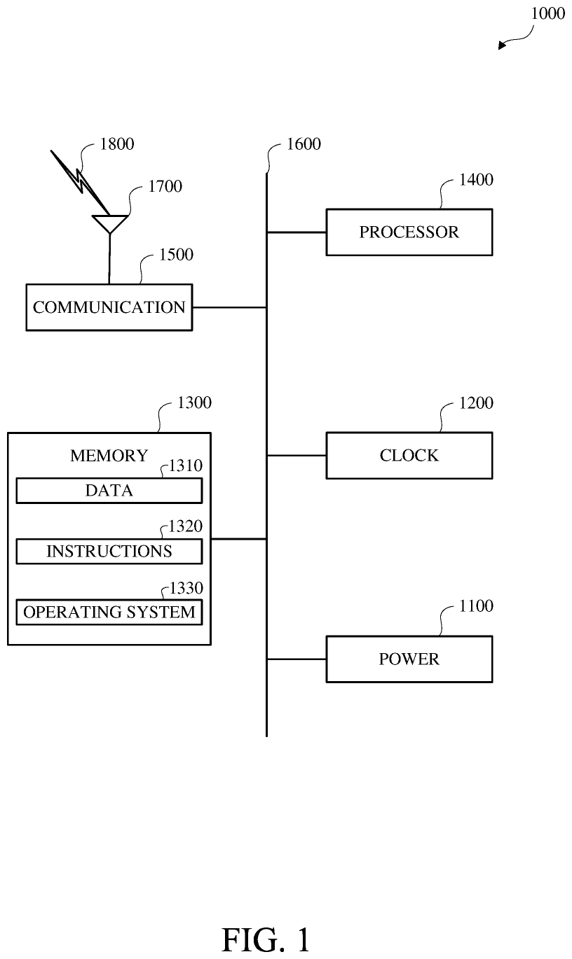

FIG. 1 is a diagram of an example of a computing and communication device 1000. As shown, the computing and communication device 1000 includes a power component 1100, a system clock 1200, memory 1300, a processor 1400, an electronic communication unit 1500, and a system bus 1600. The computing and communication device 1000 may include other components (not expressly shown), such as a user interface component. As used herein, the terminology “computer” and “computing and communication device” indicates a device, a combination of devices, or a device component, that performs, is capable of performing, or is configured to perform one or more of the methods, or one or more portion or portions thereof, disclosed herein.

The power component 1100 powers, or supplies electrical energy to, the computing and communication device 1000. Although shown as a singular unit, the power component 1100 may include multiple power components. For example, the power component 1100 may be, or may include, a wired interface for connecting to an external power source. In another example, the power component 1100 may be, or may include, one or more batteries, such as a dry cell battery, a nickel-cadmium (NiCd) battery, a nickel-zinc (NiZn) battery, a nickel metal hydride (NiMH) battery, a lithium-ion (Li-ion) battery, or a combination thereof. In some implementations, the power component 1100 may be, or may include, a wireless power interface. Although not expressly shown in FIG. 1, the power component 1100 may include internal memory, such as an internal buffer or register.

The system clock 1200 maintains, or measures, temporal or chronometric data, such as system time, for the computing and communication device 1000, and one or more of the components thereof. For example, the system clock 1200 may be implemented as a programmable interval timer that periodically interrupts the processor 1400, or one or more other components of the computing and communication device 1000 to perform one or more timekeeping operations, such as incrementing the system time.

The memory 1300 is capable of storing, or otherwise tangibly containing, data. The memory 1300 may be, or may include, one or more tangible non-transitory computer-usable or computer-readable medium or device that stores, or otherwise tangibly contains, electronic data 1310, instructions 1320, an operating system 1340, or data associated therewith, such as for use or access by the other components of the computing and communication device 1000. For example, the memory 1300 may be, or may include, one or more disks, such as one or more hard disks, one or more floppy disks, or one or more optical disks, one or more drives, such as one or more hard drives or one or more solid-state drives, one or more cards, one or more removable media, such as one or more memory cards, one or more read-only memory (ROM) components, one or more random-access memory (RAM) components, one or more magnetic cards, or one or more optical cards, one or more circuits, such as one or more application-specific integrated circuits (ASICs), one or more buffers, one or more registers, one or more semiconductor memory devices, or one or more other types of non-transitory media suitable for storing electronic information, or one or more combinations thereof. Although the memory 1300 is shown as a single unit in FIG. 1, the memory 1300 may include multiple memory units.

The data 1310 may be, or may include, information, such as a digital signal or other electronic information now-existing or hereafter developed, that may be read, or accessed, by one or more of the other components of the computing and communication device to perform a method, or one or more portions thereof, described herein. The data 1310 may be, or may include, information generated, stored, or written, by one or more of the other components of the computing and communication device performing a method, or one or more portions thereof, described herein. Although shown as a single unit, the data 1310 may include multiple physical or logical portions.

The instructions 1320 may be, or may include, directions or expressions thereof, such as code or script, which may be in a high-level language form, an intermediate form, an executable form, or a combination thereof, that define or describe one or more operations, or sequences thereof, for performing one or more of the methods, or a portion or portions thereof, disclosed herein. The instructions 1320, or a portion or portions thereof, may be realized, or implemented, as hardware, software, or a combination thereof. The instructions 1320 may be, or may include, one or more files, or a portion or portions thereof, one or more libraries, or a portion or portions thereof, one or more modules, or a portion or portions thereof, microcode, or a portion or portions thereof, firmware, or a portion or portions thereof, one or more computer programs, or a portion or portions thereof, or the like. Although shown as a single unit, the instructions 1320 may include multiple physical or logical portions. In some implementations, the instructions 1320, or a portion or portions thereof, may be implemented as a special purpose processor, circuitry, or other specialized hardware, for performing one or more method, or a portion or portions thereof, described herein.

The processor 1400 is capable of performing, or executing, one or more operations on the data 1310 to perform a method, or a portion or portions thereof, as described herein, which may include controlling one or more of the other components of the computing and communication device 1000, or a portion or portions thereof. The processor 1400 may be, or may include, one or more optical processors, one or more quantum processors, one or more molecular processors, or a combination thereof. The processor 1400 may be, or may include, one or more special purpose processors, one or more central processing units (CPUs), one or more graphics processing units (GPUs), one or more digital signal processors (DSPs), one or more microprocessors, with or without a digital signal processor core, one or more controllers, one or more microcontrollers, one or more application processors, one or more integrated circuits (ICs), one or more Application Specific Integrated Circuits (ASICs), one or more application specific standard products, one or more Field Programmable Gate Array (FPGAs), one or more programmable logic arrays, one or more programmable logic controllers, or a combination thereof. Although shown as a single unit, the processor 1400 may include multiple physical or logical units. For example, the processor 1400 may include one or more central processing units, one or more graphics processing units, and other processing circuitry operating in combination. Although not expressly shown in FIG. 1, the processor 1400 may include internal memory, such as an internal buffer or register. For example, the processor 1400 may read, or otherwise access, the data 1310, or one or more portions thereof, the instructions 1320, or one or more portions thereof, or a combination thereof, from the memory 1300 into an internal memory (not shown) of the processor 1400. As used herein, the terminology “processor” indicates one or more hardware processors, one or more virtual, or software, processors, such as one or more state machines, or a combination of one or more hardware processors and one or more virtual, or software, processors.

The electronic communication unit 1500 is capable of transmitting, receiving, or transmitting and receiving, a signal or signals via one or more communication mediums 1800, such as one or more wired communication mediums, one or more wireless communication mediums, or one or more combinations of wired and wireless communication mediums, to perform or in conjunction with the performance of, a method, or a portion or portions thereof, as described herein. For example, the one or more communication mediums 1800 may be, or may include, one or more radio frequency (RF) communication mediums, one or more ultraviolet (UV) communication mediums, one or more visible light communication mediums, one or more fiber optic communication mediums, one or more wireline communication mediums, or a combination thereof. Although shown as a single unit, the electronic communication unit 1500 may include multiple physical or logical units. Although not expressly shown in FIG. 1, the electronic communication unit 1500 may include internal memory, such as an internal buffer or register. In some implementations, the electronic communication unit 1500 is, or includes, a satellite-based navigation and positioning system transmitter, such as a Global Positioning System transmitter, a satellite-based navigation and positioning system receiver, such as a Global Positioning System receiver, or both.

The electronic communication unit 1500 may include, or may be operatively coupled with or connected to, an electronic communication interface 1700, such as an antenna, as shown, or a port. Although the electronic communication interface 1700 is shown in FIG. 1 as a single antenna, for electronic communication via wireless communication medium, the electronic communication interface 1700 may be, or may include, one or more wireless antennas, one or more wired communication ports, such as one or more Ethernet ports, one or more infrared ports, one or more serial port, one or more high-definition multimedia interface (HDMI) ports, one or universal serial bus (USB) ports, or one or more other ports or interfaces for electronic communication via one or more wired communication mediums, or a combination thereof.

The electronic communication unit 1500 is shown as including, or as operatively connected to, a wireless electronic communication interface 1700, such as an antenna, for electronic communication via wireless communication medium. Although shown as a single unit, the electronic communication interface 1700 may include multiple physical or logical units.

The system bus 1600 operatively connects, or couples, one or more of the components of the computing and communication device 1000. The system bus 1600 carries, or transports, one or more signals, such as data signals, power signals, or both, among one or more of the components of the computing and communication device 1000. Although shown as a single unit, the system bus 1600 may include multiple physical or logical units. For example, the system bus 1600 may be, or may be included in, a motherboard, or another type of printed circuit board (PCB).

The power component 1100 is operatively coupled with, or connected to, such as via the system bus 1600, one or more of the other components of the computing and communication device 1000, such as the system clock 1200, the memory 1300, the processor 1400, the electronic communication unit 1500, or the electronic communication interface 1700, to power the computing and communication device 1000, or one or more of the components thereof.

Satellite-based navigation and positioning system signals include one or more satellite-based navigation and positioning system signal types. For example, Global Positioning System signals include a first signal type (L1 C/A), a second signal type (L2C), a third signal type (L5), and a fourth signal type (L1C). The Global Positioning System signals are transmitted using a first signal frequency (L1), such as 1575.42 MHZ, and as second signal frequency (L2), such as 1227.60 MHz.

Satellite-based navigation and positioning system signals may include sequences of frames having a defined temporal frame duration, such as thirty seconds, and a defined frame data size, such as 1500 bits. A satellite-based navigation and positioning system signal frame may be subdivided into a defined number, count, or cardinality of subframes, such as five subframes. The subframes may have a defined temporal duration, such as six seconds. The subframes may have a defined size, such as ten thirty-bit words. Satellite-based navigation and positioning system signals include ranging signals, navigation messages, or both. Satellite-based navigation and positioning system signals may include data other than the data described herein.

The navigation messages include almanac data that describes the course, or low-resolution, such as within 1500 meters, orbital location of the satellites (space vehicles) in the satellite-based navigation and positioning system. The almanac data may be subdivided into a defined number, count, or cardinality of portions, or pages, such as twenty-five pages. The almanac data may have a defined almanac data size, such as 15,000 bits. One or more portions, or pages, of the almanac data may be included in one or more satellite-based navigation and positioning system subframes. For example, a portion, or page, of the almanac data may be signaled in a respective subframe. Signaling, or transmitting, the almanac data may have a defined temporal length, such as twelve minutes and thirty seconds, including a defined number, count, or cardinality of frames, such as twenty-five frames. The almanac data may include almanac data other than the almanac data described herein.

The navigation messages include ephemeris data that describes the high-resolution, such as within five (5) meters, orbital location of the signaling satellite. The ephemeris data may include ephemeris data other than the ephemeris data described herein.

The terrestrial receivers use previously obtained, currently valid, almanac data at initiation, or startup, to determine currently accessible, or visible, satellite-based navigation and positioning system satellites. The terrestrial receivers may use the almanac data to coordinate satellite-based navigation and positioning system time with terrestrial time, such as Coordinated Universal Time (UTC). The terrestrial receivers may use the almanac data to correct for atmospheric, such as ionospheric delay. A currently active satellite-based navigation and positioning system satellite to which a terrestrial receiver currently has a sufficiently unobstructed, direct (line of sight), signal path such that signals transmitted by the satellite are accurately received by the terrestrial receiver is a currently accessible satellite.

The terrestrial receivers use the ephemeris data to perform trilateration. For example, a terrestrial receiver may use ephemeris data to accurately geolocate the terrestrial receiver and may use the accurate geolocation of the terrestrial receiver for vehicle navigation, such as from a current location of the terrestrial receiver (origin) to a defined destination, which may include obtaining turn-by-turn directions for optimized routes from the origin to the destination, minimizing time to destination, such as by avoiding delays, such as traffic delays. The terrestrial receivers use the current location of the terrestrial receiver, the defined destination, or both to obtain current traffic data. In some implementations, the terrestrial receivers may report, send, transmit, or otherwise make available, such as periodically, data indicating the current location of the terrestrial receiver, obtained in accordance with the satellite-based navigation and positioning system, to an external, remote, system, such as an emergency dispatch system. The emergency dispatch system may use the location data of respective terrestrial receivers to identify terrestrial receivers proximate to respective destinations, to track the terrestrial receiver locations, or a combination thereof.

Due to practical limitations, such as orbital perturbations of the satellites, clock drift, atmospheric effects, and system changes, such as the activation or deactivation of satellites, the satellite-based navigation and positioning system information, as received by terrestrial receivers, signaled by satellite-based navigation and positioning system satellites degrades, or loses accuracy and reliability, over time. Satellite-based navigation and positioning system information that is inaccurate, degraded, or stale, such as almanac data obtained greater than one hundred eighty days, or 4320 hours, prior to the current temporal location, or ephemeris data obtained greater than four hours prior to the current temporal location, is ineligible, or ineffective, for use.

To ensure that accurate, eligible for use, satellite-based navigation and positioning system information is available, and eligible, for use, such as for geolocation and navigation, unobstructed terrestrial receivers continuously, or substantially continuously, obtain, such as receive, satellite-based navigation and positioning system signals including satellite-based navigation and positioning system information for updating, or replacing, previously obtained almanac and ephemeris data, except as is described herein or as is otherwise clear from context.

Due to practical limitations, such as current interference, a current obstruction, such as foliage, terrain, buildings, tunnels, and other current obstructions, a combination of obstructions, or a combination of one or more obstructions and interference, that, individually or cumulatively, attenuate, block, weaken, corrupt, or otherwise interfere with the reception of satellite-based navigation and positioning system signals, the regular, consistent, and accurate reception of satellite-based navigation and positioning system signals may be unavailable for obstructed terrestrial receivers. The satellite-based navigation and positioning system information, such as the almanac data, the ephemeris data, or both, for obstructed terrestrial receivers degrades and, over time, becomes stale and ineligible, or ineffective, for use.

An unobstructed terrestrial receiver that has accurately received satellite-based navigation and positioning system information, such as almanac data, ephemeris data, or both, that is currently valid, such as received within four hours of the current temporal location, may use the satellite-based navigation and positioning system information for geolocation and navigation (hot start), such as within a few seconds, such as less than thirty seconds (time to first fix).

An unobstructed terrestrial receiver that has satellite-based navigation and positioning system information, such as almanac data, ephemeris data, or both, received greater than or equal to four hours prior to the current temporal location, or for which valid almanac data is available and valid ephemeris data is otherwise unavailable, may obtain current, valid, ephemeris data by receiving satellite-based navigation and positioning system signals for a temporal duration of at least a minimum warm start temporal duration, such as one minute, in accordance with the transmission rate of the ephemeris data in the satellite-based navigation and positioning system signals, and may subsequently use the satellite-based navigation and positioning system information for geolocation and navigation (warm start), such as within one minute, such as less than forty-five seconds (time to first fix).

An unobstructed terrestrial receiver that has satellite-based navigation and positioning system information, such as almanac data, ephemeris data, or both, received greater than or equal to one hundred eighty days, or 4320 hours, prior to the current temporal location, or for which accurate, current, satellite-based navigation and positioning system information is otherwise unavailable, may obtain current, valid, ephemeris data, almanac data, or both by performing a cold start by continuously receiving satellite-based navigation and positioning system signals for a temporal duration of at least a minimum cold start temporal duration, such as fifteen minutes, in accordance with the transmission rate of the almanac data in the satellite-based navigation and positioning system signals, and may subsequently use the satellite-based navigation and positioning system information for geolocation and navigation (cold start).

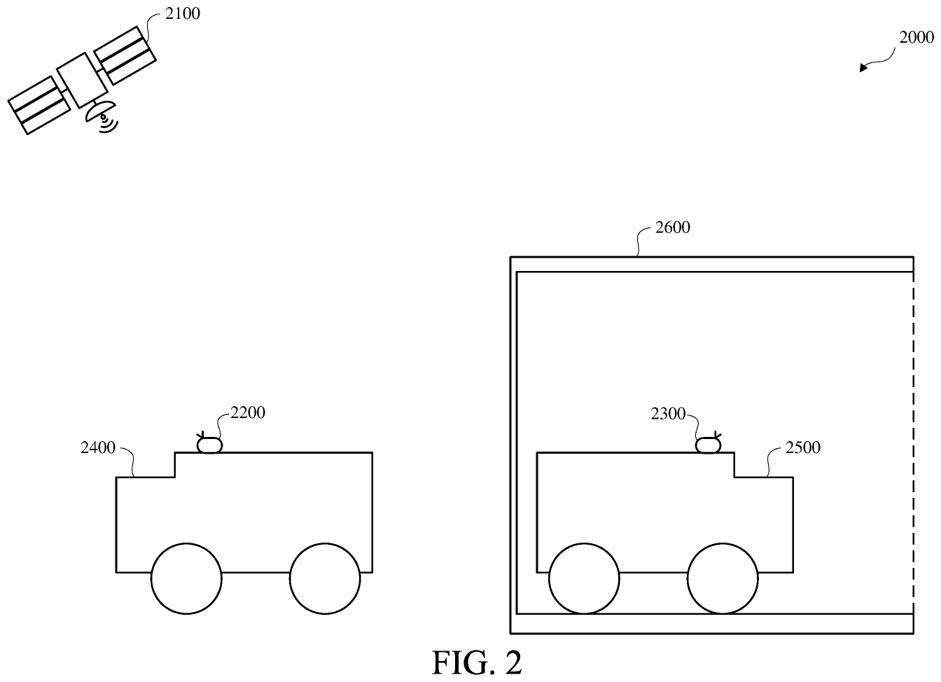

FIG. 2 is a diagram of an example of a satellite-based navigation and positioning system 2000. As shown, the satellite-based navigation and positioning system 2000 includes a satellite-based navigation and positioning system satellite 2100, a first satellite-based navigation and positioning system receiver 2200, and a second satellite-based navigation and positioning system receiver 2300. FIG. 2 shows the satellite-based navigation and positioning system 2000 at a current temporal location or point in time.

The satellite-based navigation and positioning system satellite 2100 is, or includes, a computing and communication device, such as the computing and communication device 1000 shown in FIG. 1, or one or more components thereof. Although one satellite-based navigation and positioning system satellite 2100 is shown in FIG. 2, the satellite-based navigation and positioning system 2000 may include multiple satellite-based navigation and positioning system satellites, such as a constellation of satellites. For example, the constellation of satellites may include twenty-four (24) satellites, thirty-two (32) satellites, or another number, count, or cardinality of satellites.

The first satellite-based navigation and positioning system receiver 2200 is, or includes, a computing and communication device, such as the computing and communication device 1000 shown in FIG. 1, or one or more components thereof. The first satellite-based navigation and positioning system receiver 2200 is shown in combination with, such as attached to, mounted on, or incorporated in a first vehicle 2400, such as an emergency response vehicle, such as a firetruck, an ambulance, a police car, or the like. Although the first vehicle 2400 is shown as a land craft, the vehicle may be an aircraft, a watercraft, or any other type of vehicle. In some implementations, the first satellite-based navigation and positioning system receiver 2200 may be independent of the first vehicle 2400. For example, the first satellite-based navigation and positioning system receiver 2200 may be, or may be incorporated in, a mobile device. The first satellite-based navigation and positioning system receiver 2200 is shown in an unobstructed location with respect the concurrent location of the satellite-based navigation and positioning system satellite 2100, such as outside, in the absence of a current obstruction, or a combination of obstructions, such as foliage, terrain, buildings, and other current obstructions, that, individually or cumulatively, attenuate, block, weaken, corrupt, or otherwise interfere with the regular, consistent, and accurate reception of satellite-based navigation and positioning system signals sent by the satellite-based navigation and positioning system satellite 2100.

The second satellite-based navigation and positioning system receiver 2300 is, or includes, a computing and communication device, such as the computing and communication device 1000 shown in FIG. 1, or one or more components thereof. The second satellite-based navigation and positioning system receiver 2300 is shown in combination with, such as attached to, mounted on, or incorporated in a second vehicle 2500, such as an emergency response vehicle, such as a firetruck, an ambulance, a police car, or the like. Although the second vehicle 2500 is shown as a land craft, the vehicle may be an aircraft, a watercraft, or any other type of vehicle. In some implementations, the second satellite-based navigation and positioning system receiver 2300 may be independent of the second vehicle 2500. For example, the second satellite-based navigation and positioning system receiver 2300 may be, or may be incorporated in, a mobile device or user equipment.

The second satellite-based navigation and positioning system receiver 2300 is shown in an obstructed location with respect the concurrent location of the satellite-based navigation and positioning system satellite 2100, such as indoors, in the presence of a current obstruction 2600, or a combination of obstructions, such as foliage, terrain, buildings, and other current obstructions, that, individually or cumulatively, attenuate, block, weaken, corrupt, or otherwise interfere with the regular, consistent, and accurate reception of satellite-based navigation and positioning system signals sent by the satellite-based navigation and positioning system satellite 2100. As shown in FIG. 2, the obstruction 2600 is shown as a building, such as a garage or hangar.

As shown, the satellite-based navigation and positioning system satellite 2100 is a currently accessible satellite with respect to the first satellite-based navigation and positioning system receiver 2200, wherein the first satellite-based navigation and positioning system receiver 2200 currently has a sufficiently unobstructed, direct (line-of-sight), signal path to the satellite-based navigation and positioning system satellite 2100 such that signals transmitted by the satellite-based navigation and positioning system satellite 2100 are accurately received by the first satellite-based navigation and positioning system receiver 2200. Although one satellite (the satellite-based navigation and positioning system satellite 2100), is shown in FIG. 2 as currently accessible with respect to the first satellite-based navigation and positioning system receiver 2200, the satellite-based navigation and positioning system 2000 may include multiple, such as four, satellites that are currently accessible with respect to the first satellite-based navigation and positioning system receiver 2200. Although the satellite-based navigation and positioning system satellite 2100 is shown as a currently accessible satellite with respect to the first satellite-based navigation and positioning system receiver 2200 at the current temporal location, at another temporal location, the satellite-based navigation and positioning system satellite 2100 may be inaccessible with respect to the first satellite-based navigation and positioning system receiver 2200.

The first satellite-based navigation and positioning system receiver 2200 may continuously, or substantially continuously, accurately obtain signals transmitted by the satellite-based navigation and positioning system satellite 2100 and may continuously, or substantially continuously, maintain accurate, current, satellite-based navigation and positioning system data, including ephemeris data, almanac data, or both.

As shown, the satellite-based navigation and positioning system satellite 2100 is a currently inaccessible satellite with respect to the second satellite-based navigation and positioning system receiver 2300, wherein the second satellite-based navigation and positioning system receiver 2300 currently has an obstructed, occluded, or attenuated signal path to the satellite-based navigation and positioning system satellite 2100 such that, at the current temporal location, signals transmitted by the satellite-based navigation and positioning system satellite 2100 are inaccurately received, or unreceived, by the second satellite-based navigation and positioning system receiver 2300.

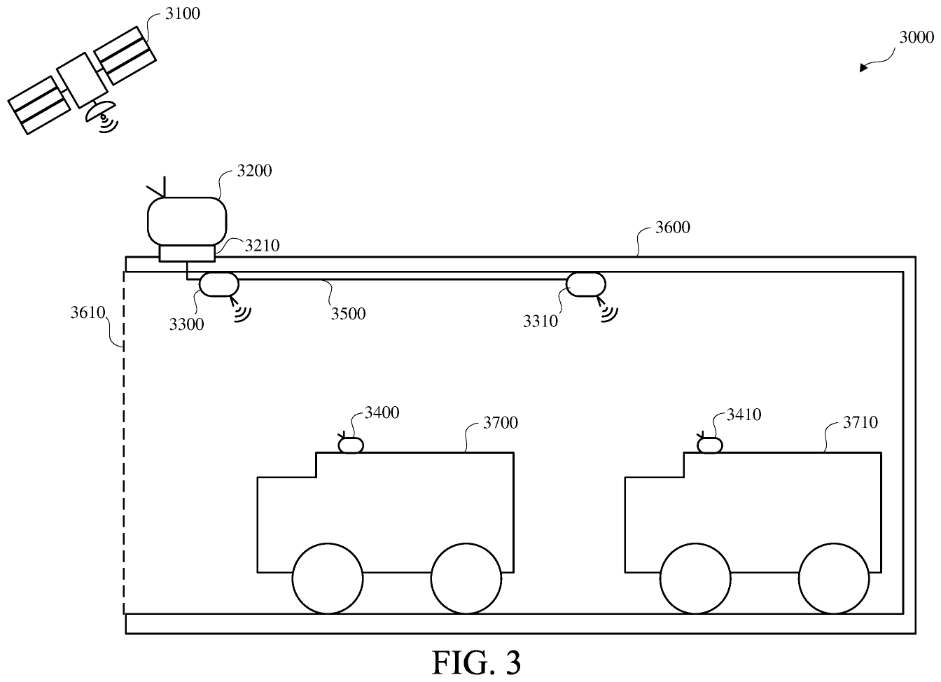

FIG. 3 is a diagram of an example of a satellite-based navigation and positioning system with interference mitigated reradiation 3000. As shown, the satellite-based navigation and positioning system with interference mitigated reradiation 3000 includes a satellite-based navigation and positioning system satellite 3100, a first satellite-based navigation and positioning system receiver 3200, a first satellite-based navigation and positioning system passive re-radiator 3300, a second satellite-based navigation and positioning system passive re-radiator 3310, a second satellite-based navigation and positioning system receiver 3400, a third satellite-based navigation and positioning system receiver 3410, and a wired electronic communication medium 3500. FIG. 3 shows the satellite-based navigation and positioning system with interference mitigated reradiation 3000 at a current temporal location or point in time. Although two satellite-based navigation and positioning system passive re-radiators are shown in FIG. 3, other numbers of satellite-based navigation and positioning system passive re-radiators may be used. Although three satellite-based navigation and positioning system receivers are shown in FIG. 3, other numbers of satellite-based navigation and positioning system receivers may be used. The first satellite-based navigation and positioning system receiver 3200, the first satellite-based navigation and positioning system passive re-radiator 3300, the second satellite-based navigation and positioning system passive re-radiator 3310, and the wired electronic communication medium 3500 may be collectively referred to herein as a satellite-based navigation and positioning system re-radiation system.

The satellite-based navigation and positioning system satellite 3100 is similar to the satellite-based navigation and positioning system satellite 2100 shown in FIG. 2. As shown, the satellite-based navigation and positioning system satellite 3100 is a currently accessible satellite with respect to the first satellite-based navigation and positioning system receiver 3200, wherein the first satellite-based navigation and positioning system receiver 3200 currently has a sufficiently unobstructed, direct (line of sight), signal path such that signals transmitted by the satellite-based navigation and positioning system satellite 3100 are accurately received by the first satellite-based navigation and positioning system receiver 3200. Although one satellite (the satellite-based navigation and positioning system satellite 3100), is shown in FIG. 3 as currently accessible with respect to the first satellite-based navigation and positioning system receiver 3200, the satellite-based navigation and positioning system with interference mitigated reradiation 3000 may include multiple, such as three, satellites that are currently accessible with respect to the first satellite-based navigation and positioning system receiver 3200. Although the satellite-based navigation and positioning system satellite 3100 is shown as a currently accessible satellite with respect to the first satellite-based navigation and positioning system receiver 3200 at the current temporal location, at another temporal location, the satellite-based navigation and positioning system satellite 3100 may be inaccessible with respect to the first satellite-based navigation and positioning system receiver 3200.

The first satellite-based navigation and positioning system receiver 3200 is, or includes, a computing and communication device, such as the computing and communication device 1000 shown in FIG. 1, or one or more components thereof. The first satellite-based navigation and positioning system receiver 3200 is shown in combination with, such as attached to, mounted on, incorporated with, or otherwise arranged, on, or near, an exterior surface of a building 3600, such as a garage, a vehicle bay, or a hangar.

For example, the first satellite-based navigation and positioning system receiver 3200 may be, or may include, a roof-mounted active satellite-based navigation and positioning system signal antenna that receives live-sky satellite-based navigation and positioning system signals from the satellite-based navigation and positioning system constellation, including receiving signals from the satellite-based navigation and positioning system satellite 3100 at the current temporal location. The first satellite-based navigation and positioning system receiver 3200 is shown in an unobstructed location with respect the concurrent location of the satellite-based navigation and positioning system satellite 3100, such as outside, in the absence of a current obstruction, or a combination of obstructions, such as foliage, terrain, buildings, and other current obstructions, that, individually or cumulatively, attenuate, block, weaken, corrupt, or otherwise interfere with the regular, consistent, and accurate reception of satellite-based navigation and positioning system signals sent by the satellite-based navigation and positioning system satellite 3100.

The first satellite-based navigation and positioning system receiver 3200 may continuously, or substantially continuously, accurately obtain signals transmitted by the satellite-based navigation and positioning system satellite 3100 and may continuously, or substantially continuously, maintain accurate, current, satellite-based navigation and positioning system data, including ephemeris data, almanac data, or both. The first satellite-based navigation and positioning system receiver 3200 may omit, skip, or exclude processing the received satellite-based navigation and positioning system signals, other than receiving, storing, and sending the satellite-based navigation and positioning system signals as described herein, except as is described herein or as is otherwise clear from context.

The building 3600 is an obstacle to satellite-based navigation and positioning system signals transmitted by the satellite-based navigation and positioning system satellite 3100. The building 3600 is shown as having an exit 3610 at the left (as indicated by a broken line). The first satellite-based navigation and positioning system receiver 3200 is shown as mounted proximate to, above, the building 3600 exit 3610. Other mounting locations may be used. The interior of the building 3600 is an obstructed location or environment with respect to satellite-based navigation and positioning system signals transmitted by the satellite-based navigation and positioning system satellite 3100.

To ensure that accurate, eligible for use, satellite-based navigation and positioning system information is available, and eligible, for use, such as for geolocation and navigation, in obstructed locations and environments, such as the interior of the building 3600, satellite-based navigation and positioning system signals may be received by an unobstructed satellite-based navigation and positioning system receiver, such as the first satellite-based navigation and positioning system receiver 3200, and may be re-radiated, such as by the satellite-based navigation and positioning system re-radiators 3300, 3310, in otherwise obstructed locations and environments, such as the interior of the building 3600. Unconstrained re-radiated satellite-based navigation and positioning system signals transmitted in environments that are unobstructed with respect to satellite-based navigation and positioning system signals transmitted by the satellite-based navigation and positioning system constellation, such as by the satellite-based navigation and positioning system satellite 3100, may cause interference with the satellite-based navigation and positioning system signals transmitted by the satellite-based navigation and positioning system constellation.

The first satellite-based navigation and positioning system receiver 3200 is operatively coupled with, or combined with, a satellite-based navigation and positioning system re-radiating amplifier 3210. The re-radiating amplifier 3210 boosts the signal power of the satellite-based navigation and positioning system signals received by the first satellite-based navigation and positioning system receiver 3200, such as by a defined amount, such as by thirty-three decibels. For example, the satellite-based navigation and positioning system signals received by the first satellite-based navigation and positioning system receiver 3200 may have a signal strength of −130 decibel-milliwatts (dBm) and the re-radiating amplifier 3210 may amplify the received satellite-based navigation and positioning system signal, such as by thirty-three decibels. The amount of signal amplification may be defined, or configured, in accordance with one or more characteristics of the satellite-based navigation and positioning system re-radiation system, such as the length of the wired electronic communication medium 3500.

The first satellite-based navigation and positioning system receiver 3200, the satellite-based navigation and positioning system re-radiating amplifier 3210, or the combination thereof, sends, transmits, or otherwise makes available, the amplified satellite-based navigation and positioning system signal received by the first satellite-based navigation and positioning system receiver 3200 to the first satellite-based navigation and positioning system passive re-radiator 3300, the second satellite-based navigation and positioning system passive re-radiator 3310, or both via the wired electronic communication medium 3500. For example, the wired electronic communication medium 3500 may be coax cable.

The first satellite-based navigation and positioning system passive re-radiator 3300 is, or includes, a computing and communication device, such as the computing and communication device 1000 shown in FIG. 1, or one or more components thereof. For example, the first satellite-based navigation and positioning system passive re-radiator 3300 may include a microcontroller. The first satellite-based navigation and positioning system passive re-radiator 3300 is operatively coupled with the wired electronic communication medium 3500. The first satellite-based navigation and positioning system passive re-radiator 3300 includes a satellite-based navigation and positioning system signal re-radiating antenna. The first satellite-based navigation and positioning system passive re-radiator 3300 is mounted at, or near, an interior surface of the building 3600, such as on a ceiling of the vehicle bay. The satellite-based navigation and positioning system signal re-radiating antenna of the first satellite-based navigation and positioning system passive re-radiator 3300 is positioned, directed, configured, or arranged to direct satellite-based navigation and positioning system signals re-radiated by the satellite-based navigation and positioning system signal re-radiating antenna of the first satellite-based navigation and positioning system passive re-radiator 3300 away from, such as directly away from, the building 3600 exit 3610. A portion, such as a rear, or back, lobe of the satellite-based navigation and positioning system signal re-radiating antenna of the first satellite-based navigation and positioning system passive re-radiator 3300 is shielded to minimize, or prevent, the radiation, transmission, or emission of re-radiated satellite-based navigation and positioning system signals into unobstructed environments, such as outside the building 3600.

The second satellite-based navigation and positioning system passive re-radiator 3310 is, or includes, a computing and communication device, such as the computing and communication device 1000 shown in FIG. 1, or one or more components thereof. For example, the second satellite-based navigation and positioning system passive re-radiator 3310 may include a microcontroller. The second satellite-based navigation and positioning system passive re-radiator 3310 is operatively coupled with the wired electronic communication medium 3500. The second satellite-based navigation and positioning system passive re-radiator 3310 includes a satellite-based navigation and positioning system signal re-radiating antenna. The second satellite-based navigation and positioning system passive re-radiator 3310 is mounted at, or near, an interior surface of the building 3600, such as on a ceiling of the vehicle bay. The satellite-based navigation and positioning system signal re-radiating antenna of the second satellite-based navigation and positioning system passive re-radiator 3310 is positioned, directed, configured, or arranged to direct satellite-based navigation and positioning system signals re-radiated by the satellite-based navigation and positioning system signal re-radiating antenna of the second satellite-based navigation and positioning system passive re-radiator 3310 away from, such as directly away from, the building 3600 exit 3610. A portion, such as a rear, or back, lobe of the satellite-based navigation and positioning system signal re-radiating antenna of the second satellite-based navigation and positioning system passive re-radiator 3310 is shielded to minimize, or prevent, the radiation, transmission, or emission of re-radiated satellite-based navigation and positioning system signals into unobstructed environments, such as outside the building 3600.

The second satellite-based navigation and positioning system receiver 3400 is, or includes, a computing and communication device, such as the computing and communication device 1000 shown in FIG. 1, or one or more components thereof. The second satellite-based navigation and positioning system receiver 3400 is shown in combination with, such as attached to, mounted on, or incorporated in a first vehicle 3700, such as an emergency response vehicle, such as a firetruck, an ambulance, a police car, or the like. Although the first vehicle 3700 is shown as a land craft, the vehicle may be an aircraft, a watercraft, or any other type of vehicle. In some implementations, the second satellite-based navigation and positioning system receiver 3400 may be independent of the first vehicle 3700. For example, the second satellite-based navigation and positioning system receiver 3400 may be, or may be incorporated in, a mobile device or user equipment. The second satellite-based navigation and positioning system receiver 3400 is shown in an obstructed location with respect the concurrent location of the satellite-based navigation and positioning system satellite 3100, such as indoors, in the presence of a current obstruction, such as the building 3600, or a combination of obstructions, such as foliage, terrain, buildings, and other current obstructions, that, individually or cumulatively, attenuate, block, weaken, corrupt, or otherwise interfere with the regular, consistent, and accurate reception of satellite-based navigation and positioning system signals sent by the satellite-based navigation and positioning system satellite 3100.

The third satellite-based navigation and positioning system receiver 3410 is, or includes, a computing and communication device, such as the computing and communication device 1000 shown in FIG. 1, or one or more components thereof. The third satellite-based navigation and positioning system receiver 3410 is shown in combination with, such as attached to, mounted on, or incorporated in a second vehicle 3710, such as an emergency response vehicle, such as a firetruck, an ambulance, a police car, or the like. Although the second vehicle 3710 is shown as a land craft, the vehicle may be an aircraft, a watercraft, or any other type of vehicle. In some implementations, the third satellite-based navigation and positioning system receiver 3410 may be independent of the second vehicle 3710. For example, the third satellite-based navigation and positioning system receiver 3410 may be, or may be incorporated in, a mobile device or user equipment. The third satellite-based navigation and positioning system receiver 3410 is shown in an obstructed location with respect the concurrent location of the satellite-based navigation and positioning system satellite 3100, such as indoors, in the presence of a current obstruction, such as the building 3600, or a combination of obstructions, such as foliage, terrain, buildings, and other current obstructions, that, individually or cumulatively, attenuate, block, weaken, corrupt, or otherwise interfere with the regular, consistent, and accurate reception of satellite-based navigation and positioning system signals sent by the satellite-based navigation and positioning system satellite 3100.

As shown, the satellite-based navigation and positioning system satellite 3100 is a currently inaccessible satellite with respect to the second satellite-based navigation and positioning system receiver 3400, the third satellite-based navigation and positioning system receiver 3410, or both, wherein the second satellite-based navigation and positioning system receiver 3400, the third satellite-based navigation and positioning system receiver 3410, or both currently have obstructed, occluded, or attenuated signal paths to the satellite-based navigation and positioning system satellite 3100 such that satellite-based navigation and positioning system signals transmitted by the satellite-based navigation and positioning system satellite 3100 are inaccurately received, or unreceived, by the second satellite-based navigation and positioning system receiver 3400, the third satellite-based navigation and positioning system receiver 3410, or both.

In the absence of the satellite-based navigation and positioning system signal reradiation described herein, ephemeris data previously, such as prior to the current temporal location, obtained by the currently obstructed satellite-based navigation and positioning system receivers 3400, 3410 begins degrading at a temporal location corresponding to the respective satellite-based navigation and positioning system receiver 3400, 3410 becoming obstructed, such as by entering the building 3600, and is ineligible for use at a temporal location at a defined temporal distance, such as four hours, subsequent to the respective satellite-based navigation and positioning system receiver 3400, 3410 becoming, and remaining, obstructed.

In the absence of the satellite-based navigation and positioning system signal reradiation described herein, almanac data previously, such as prior to the current temporal location, obtained by the currently obstructed satellite-based navigation and positioning system receivers 3400, 3410 begins degrading at a temporal location corresponding to the respective satellite-based navigation and positioning system receiver 3400, 3410 becoming obstructed, such as by entering the building 3600, and is ineligible for use at a temporal location at a defined temporal distance, such as 4320 hours, subsequent to the respective satellite-based navigation and positioning system receiver 3400, 3410 becoming, and remaining, obstructed.

The satellite-based navigation and positioning system signals reradiated by the satellite-based navigation and positioning system passive re-radiators 3300, 3310 are unusable as received at distances from the first satellite-based navigation and positioning system passive re-radiator 3300 greater than a defined distance, such as twenty meters.

Attributes of the satellite-based navigation and positioning system re-radiation system are shown in Table 1 with respect to using the example of the Global Positioning System first signal frequency (L1).

TABLE 1

| | | | Signal Level | | |
|---|---|---|---|---|---|
| Attribute | Value | Units | dBm | Watts | picoWatts |
| Frequency | 1575.42 | MHz | | | |
| Wavelength | 0.19029 | Meters | | | |
| GPS Input Signal Level | −130 | dBm | −130 | 1.00E−16 | 1.00E−04 |
| GPS Receive Antenna amplifier | 38 | dB | −92.00 | 6.31E−13 | 6.31E−01 |
| gain | | | | | |
| GPS RF Amplifier gain | 33 | dB | −59.00 | 1.26E−09 | 1.26E−03 |
| GPS RF Attenuator | −22 | dB | −81.00 | 7.94E−12 | 7.94 |
| LMR400 Coax loss per foot | −0.067 | dB | | | |
| Coax Length | 100 | feet | | | |
| Total Coax Loss | −6.7 | dB | −87.70 | 1.70E−12 | 1.70 |
| GPS Transmitting Antenna Gain | 3 | dB | −84.70 | 3.39E−12 | 3.39 |
| Distance from transmit antenna | 5 | Meters | | | |
| Distance from transmit antenna | 16.40 | Feet | | | |
| Pathloss to unit under test | −50.38 | dB | −135.08 | 3.11E−17 | 3.11E−05 |
| Signal level at unit under test | | | −137.22 | 1.90E−17 | 1.90E−05 |
| EIRP to ERP | | | | | |
| Distance from transmit antenna | 10 | Meters | | | |
| Distance from transmit antenna | 32.81 | Feet | | | |
| Pathloss to unit under test | −56.40 | dB | −135.08 | 3.11E−17 | 3.11E−05 |
| Signal level at unit under test | | | −141.10 | 7.77E−18 | 7.77E−06 |
| EIRP to ERP | | | | | |
| Distance from transmit antenna | 20 | Meters | | | |
| Distance from transmit antenna | 65.62 | Feet | | | |
| Pathloss to unit under test | −62.42 | dB | −147.12 | 1.94E−18 | 1.94E−06 |
| Signal level at unit under test | | | −149.26 | 1.19E−18 | 1.19E−06 |
| EIRP to ERP | | | | | |
| Distance from transmit antenna | 30 | Meters | | | |
| Distance from transmit antenna | 98.43 | Feet | | | |
| Pathloss to unit under test | −65.94 | dB | −150.64 | 8.63E−19 | 8.63E−07 |
| Signal level at unit under test | | | −152.78 | 5.27E−19 | 5.27E−07 |
| EIRP to ERP | | | | | |

Attributes of the satellite-based navigation and positioning system re-radiation system are shown in Table 2 with respect to using the example of the Global Positioning System second signal frequency (L2).

TABLE 2

| | | | Signal Level | | |
|---|---|---|---|---|---|
| Attribute | Value | Units | dBm | Watts | picoWatts |
| Frequency | 1227.60 | MHz | | | |
| Wavelength | 0.24421 | Meters | | | |
| GPS Input Signal Level | −130 | dBm | −130 | 1.00E−16 | 1.00E−04 |
| GPS Receive Antenna amplifier | 38 | dB | −92.00 | 6.31E−13 | 6.31E−01 |
| gain | | | | | |
| GPS RF Amplifier gain | 33 | dB | −59.00 | 1.26E−09 | 1.26E−03 |
| GPS RF Attenuator | −22 | dB | −81.00 | 7.94E−12 | 7.94 |
| LMR400 Coax loss per foot | −0.067 | dB | | | |
| Coax Length | 100 | feet | | | |
| Total Coax Loss | −6.7 | dB | −87.70 | 1.70E−12 | 1.70 |
| GPS Transmitting Antenna Gain | 3 | dB | −84.70 | 3.39E−12 | 3.39 |
| Distance from transmit antenna | 5 | Meters | | | |
| Distance from transmit antenna | 16.40 | Feet | | | |
| Pathloss to unit under test | −48.21 | dB | −132.91 | 5.12E−17 | 5.12E−05 |
| Signal level at unit under test | | | −135.05 | 3.13E−17 | 3.13E−05 |
| EIRP to ERP | | | | | |
| Distance from transmit antenna | 10 | Meters | | | |
| Distance from transmit antenna | 32'81 | Feet | | | |
| Pathloss to unit under test | −54.23 | dB | −138.93 | 1.28E−17 | 1.28E−05 |
| Signal level at unit under test | | | −141.07 | 782E−18 | 7,82E−06 |
| EIRP to ERP | | | | | |
| Distance from transmit antenna | 20 | Meters | | | |
| Distance from transmit antenna | 65.62 | Feet | | | |
| Pathloss to unit under test | −60.25 | dB | −144.95 | 3.20E−18 | 3.20E−06 |
| Signal level at unit under test | | | −147.09 | 1.95E−18 | 1.95E−06 |
| EIRP to ERP | | | | | |
| Distance from transmit antenna | | Meters | | | |
| Distance from transmit antenna | 30 | Feet | | | |
| Pathloss to unit under test | 98.43 | dB | | | |
| Signal level at unit under test | | | −148.47 | 1.42E−18 | 1.42E−06 |
| EIRP to ERP | | | | | |

To minimize, or eliminate, signal interference, one or more portions of the satellite-based navigation and positioning system re-radiation system, such as one or more portions of the first satellite-based navigation and positioning system receiver 3200, one or more portions of the first satellite-based navigation and positioning system passive re-radiator 3300, one or more portions of the second satellite-based navigation and positioning system passive re-radiator 3310, or a combination thereof, are operated in accordance with a defined minimal time controlled reradiation schedule.

The minimal time controlled reradiation schedule defines one or more temporal intervals and corresponding temporal durations (reradiation windows) for automatically enabling, activating, or otherwise operating one or more portions of the satellite-based navigation and positioning system re-radiation system to re-radiate the satellite-based navigation and positioning system signals received, or received and amplified, by the first satellite-based navigation and positioning system receiver 3200. At temporal locations other than during reradiation windows, the reradiation of the satellite-based navigation and positioning system signals is omitted, skipped, disabled, deactivated, or otherwise prevented.

In some implementations, the minimal time controlled reradiation schedule defines warm start reradiation windows having one-minute durations at intervals of three and a half (3.5) hours. Other warm start reradiation window intervals, less than four hours, may be used. Other warm start reradiation window durations, greater than or equal to thirty seconds, may be used. During warm start reradiation windows the second satellite-based navigation and positioning system receiver 3400, the third satellite-based navigation and positioning system receiver 3410, or both receive reradiated satellite-based navigation and positioning system signals sufficient to obtain current, accurate, ephemeris data.

In some implementations, the minimal time controlled reradiation schedule defines cold start reradiation windows having fifteen-minute durations at intervals of four thousand (4000) hours. Other cold start reradiation window intervals, less than 4320 hours, may be used. Other cold start reradiation window durations, greater than or equal to a minimum almanac data acquisition duration, may be used. In some implementations, the minimum almanac data acquisition duration may correspond to the time to signal the almanac data, 12.5 minutes. In some implementations, satellite-based navigation and positioning system signals may be currently, or substantially concurrently, received from multiple satellites and the minimum almanac data acquisition duration may be less than 12.5 minutes. During cold start reradiation windows the second satellite-based navigation and positioning system receiver 3400, the third satellite-based navigation and positioning system receiver 3410, or both receive reradiated satellite-based navigation and positioning system signals sufficient to obtain current, accurate, almanac data, in addition to, or instead of, current, accurate, ephemeris data. In some implementations, the cold start reradiation windows may have intervals of ninety days.

In some implementations, the minimal time controlled reradiation schedule defines hot start reradiation windows having thirty second durations at intervals of one hour. Other hot start reradiation window intervals may be used. Other hot start reradiation window durations may be used. During hot start reradiation windows the second satellite-based navigation and positioning system receiver 3400, the third satellite-based navigation and positioning system receiver 3410, or both receive reradiated satellite-based navigation and positioning system signals, such as ephemeris data, sufficient to determine the geospatial location of the respective satellite-based navigation and positioning system receiver 3400, 3410.

In some implementations, respective components of the satellite-based navigation and positioning system passive re-radiators 3300, 3310, such as respective microcontrollers thereof, implement the minimal time controlled reradiation schedule. In some implementations, instead of, or in addition to, respective components of the satellite-based navigation and positioning system passive re-radiators 3300, 3310, implementing the minimal time controlled reradiation schedule, the first satellite-based navigation and positioning system receiver 3200, or a component thereof, such as a microcontroller thereof, implements the minimal time controlled reradiation schedule.

In some implementations, the use of satellite-based navigation and positioning system with interference mitigated reradiation 3000 for geospatial positioning and navigation may be limited to determining, or testing, whether the satellite-based navigation and positioning system receiver or satellite-based navigation and positioning system receivers that receive reradiated satellite-based navigation and positioning system signals, such as the second satellite-based navigation and positioning system receiver 3400, the third satellite-based navigation and positioning system receiver 3410, or both, obtain satellite-based navigation and positioning system data, such as ephemeris data, sufficient to determine the geospatial location of the respective satellite-based navigation and positioning system receiver 3400, 3410 at respective temporal locations.

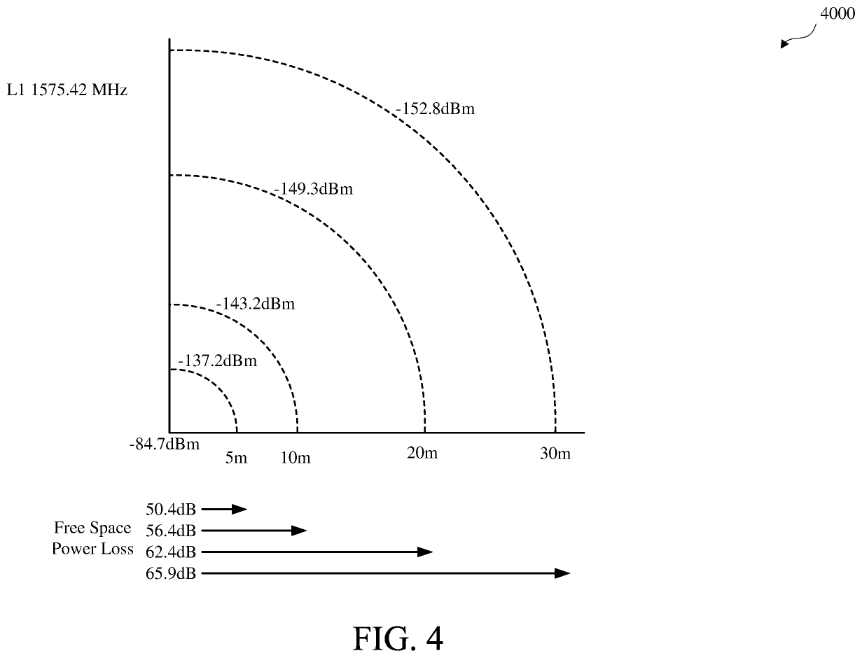

FIG. 4 is a diagram of an example of signal analysis with respect to the Global Positioning System first signal frequency (L1) 4000.

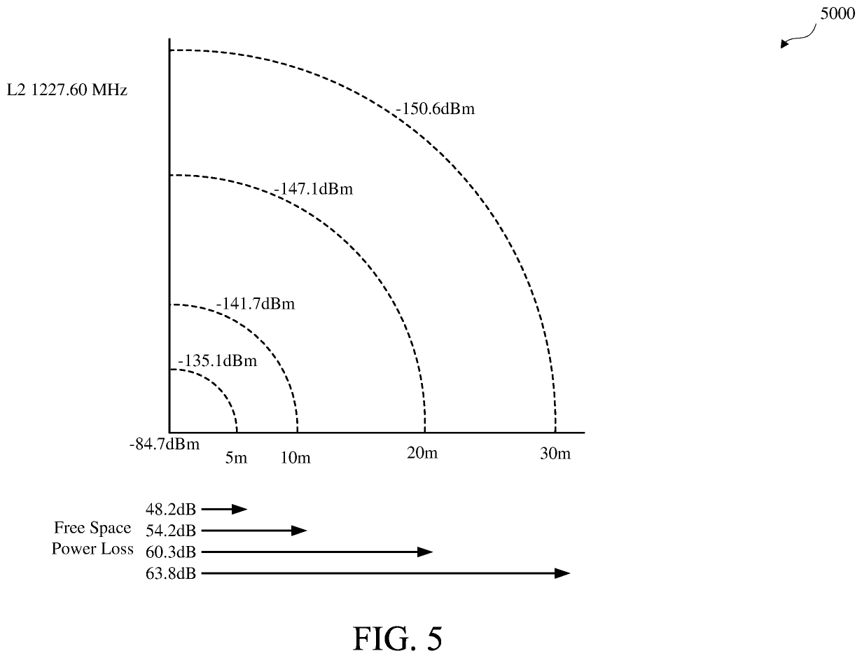

FIG. 5 is a diagram of an example of signal analysis with respect to the Global Positioning System second signal frequency (L2) 5000.

The processes, machines, articles of manufacture, compositions of matter, and improvements thereof described herein are described herein with respect to embodiments, implementations, and examples for simplicity and clarity and are non-limiting. The processes, machines, articles of manufacture, compositions of matter, and improvements thereof claimed herein are not limited to the embodiments, implementations, and examples expressly described herein and include the broadest reasonable interpretation of the claim terms, including modifications and arrangements equivalent to those expressly described herein, as is permitted under the law.

As used herein, the terminology “or” indicates an inclusive “or,” except as is expressly described herein or as is otherwise clear from context. For example, in the absence of an express or clear contextual indication otherwise, the phrase “A or B” indicates “A and not B,” “B and not A,” and “A and B.”

As used herein, the terminology “a” and “an” indicate “at least one,” except as is described herein or as is otherwise clear from context as directed to a singular form. For example, in the absence of an express or contextually clear indication otherwise, the phrase “a device that performs A and B” indicates a single device that performs A and performs B, multiple devices that respectively perform A and perform B, and multiple devices that collectively perform A and perform B, wherein at least one of the multiple devices performs A, or a portion or portions thereof, at least one of the multiple devices performs B, or a portion or portions thereof, one or more of the multiple devices that performs A, or a portion or portions thereof, may omit or skip performing B, or a portion or portions thereof, and one or ore of the multiple devices that performs B, or a portion or portions thereof, may omit or skip performing A, or a portion or portions thereof.

As used herein, the terminology “optimal”, “optimized”, “optimization”, or other forms thereof, are relative to a respective context and are not indicative of absolute theoretic optimization, except as is described herein or as is otherwise clear from context.

As used herein, the terminology “set” indicates a distinguishable collection or grouping of zero or more distinct elements or members, except as expressly described herein or otherwise clear from context. As used herein, the terminology “proper subset” indicates distinguishable collection or grouping of zero or more distinct elements or members of a set wherein at least one element or member of the set is absent, omitted, or excluded from the proper subset.

As used herein, the terminology “a processor” and “the processor” indicates one or processors, except as is described herein or as is otherwise clear from context.

As used herein, the terminology “a computer-readable medium” and “the computer-readable medium” indicates one or more computer-readable media, except as is described herein or as is otherwise clear from context.

As used herein, the terminology “determine,” “identify,” “obtain,” and “form” or any variations thereof, indicates selecting, ascertaining, computing, looking up, receiving, determining, establishing, accessing, obtaining, or otherwise identifying or determining in any manner whatsoever using one or more of the devices and methods shown and described herein.

The implementations, embodiments, examples, illustrations, and descriptions of the processes, machines, articles of manufacture, compositions of matter, and improvements thereof described herein, and the elements, aspects, features, techniques, components, parts, and portions thereof, are explanatory and may be used independently or in combination, except as is described herein or as is otherwise clear from context.

The methods described herein, or a portion or portions thereof, may be implemented as, in, or by one or more devices or apparatuses operating individually or in combination, except as is described herein or as is otherwise clear from context. The methods described herein, or a portion or portions thereof, may be implemented as, in, or by one or more systems operating individually or in combination, except as is described herein or as is otherwise clear from context. The methods described herein, or a portion or portions thereof, may be implemented as computer program instructions, which may be stored in one or more non-transitory computer-readable media, and which may be processed, executed, interpreted, or performed by one or more processors.

To the extent that the figures described herein, and the descriptions thereof, indicate sequence or order, the elements thereof, or a part or parts thereof, may be implemented or performed in another order or concurrently, except as is described herein or as is otherwise clear from context. One or more of the methods disclosed herein, or a part or parts thereof, may be implemented or performed in conjunction with, or concurrently with, elements other than the elements expressly indicated herein, except as is described herein or as is otherwise clear from context. One or more implementations of one or more of the methods disclosed herein, or a part or parts thereof, may omit or exclude one or more of the methods disclosed herein, or a part or parts thereof, except as is described herein or as is otherwise clear from context.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
operating a first satellite-based navigation and positioning system receiver having an unobstructed signal path with respect to at least one satellite-based navigation and positioning system satellite from a constellation of satellite-based navigation and positioning system satellites; and
operating, in accordance with a minimal time controlled reradiation schedule, at least one satellite-based navigation and positioning system re-radiator operatively coupled with the first satellite-based navigation and positioning system receiver via a wireline electronic communication medium, wherein the satellite-based navigation and positioning system re-radiator includes a satellite-based navigation and positioning system re-radiating antenna, wherein operating the at least one satellite-based navigation and positioning system re-radiator in accordance with the minimal time controlled reradiation schedule includes:
automatically preventing the at least one satellite-based navigation and positioning system re-radiator from reradiating satellite-based navigation and positioning system signals at temporal locations other than temporal locations in one or more reradiation windows defined by the minimal time controlled reradiation schedule; and
automatically operating the at least one satellite-based navigation and positioning system re-radiator to reradiate satellite-based navigation and positioning system signals obtained from the first satellite-based navigation and positioning system receiver at temporal locations in the one or more reradiation windows defined by the minimal time controlled reradiation schedule to zero or more second satellite-based navigation and positioning system receivers.

2. The method of claim 1, wherein the one or more reradiation windows include:
at least one hot start reradiation window having an interval of one hour and having a duration of thirty second;
at least one warm start reradiation window having an interval of three and a half hours and having a duration of one minute; and
at least one cold start reradiation window having an interval of four thousand hours and having a duration of fifteen minutes.

3. The method of claim 1, wherein the one or more reradiation windows include:
at least one hot start reradiation window having an interval of one hour and having a duration of thirty seconds.

4. The method of claim 1, wherein the one or more reradiation windows include:
at least one warm start reradiation window having an interval of three and a half hours and having a duration of one minute.

5. The method of claim 1, wherein the one or more reradiation windows include:
at least one cold start reradiation window having an interval of four thousand hours and having a duration of fifteen minutes.

6. The method of claim 1, wherein the first satellite-based navigation and positioning system receiver has:
a first unobstructed signal path with respect to a first satellite-based navigation and positioning system satellite from the constellation of satellite-based navigation and positioning system satellites;
a second unobstructed signal path with respect to a second satellite-based navigation and positioning system satellite from the constellation of satellite-based navigation and positioning system satellites; and
a third unobstructed signal path with respect to a third satellite-based navigation and positioning system satellite from the constellation of satellite-based navigation and positioning system satellites.

7. The method of claim 1, wherein operating the first satellite-based navigation and positioning system receiver includes operating the first satellite-based navigation and positioning system receiver such that the first satellite-based navigation and positioning system receiver substantially continuously receives satellite-based navigation and positioning system signals transmitted by the constellation of satellite-based navigation and positioning system satellites.

8. The method of claim 1, wherein the first satellite-based navigation and positioning system receiver is mounted on an exterior surface of a satellite-based navigation and positioning system signal obstructing vehicle bay proximate to an exit of the satellite-based navigation and positioning system signal obstructing vehicle bay.

9. The method of claim 8, wherein:
the at least one satellite-based navigation and positioning system re-radiator is mounted on an interior surface of the of the satellite-based navigation and positioning system signal obstructing vehicle bay such that satellite-based navigation and positioning system signals reradiated by the satellite-based navigation and positioning system re-radiator are directed away from the exit, wherein at least a portion of the satellite-based navigation and positioning system re-radiating antenna proximate to the exit is shielded; and
the zero or more second satellite-based navigation and positioning system receivers are spatially located within the vehicle bay such that the zero or more second satellite-based navigation and positioning system receivers are obstructed from otherwise receiving the satellite-based navigation and positioning system signals transmitted by the constellation of satellite-based navigation and positioning system satellites.

10. A system comprising:
a first satellite-based navigation and positioning system receiver having an unobstructed signal path with respect to at least one satellite-based navigation and positioning system satellite from a constellation of satellite-based navigation and positioning system satellites; and
a satellite-based navigation and positioning system re-radiator operatively coupled with the first satellite-based navigation and positioning system receiver via a wireline electronic communication medium, wherein the satellite-based navigation and positioning system re-radiator includes a satellite-based navigation and positioning system re-radiating antenna, wherein the satellite-based navigation and positioning system re-radiator includes a microcontroller configured to control the satellite-based navigation and positioning system re-radiator in accordance with a minimal time controlled reradiation schedule, wherein to control the satellite-based navigation and positioning system re-radiator in accordance with the minimal time controlled reradiation schedule, the microcontroller controls the satellite-based navigation and positioning system re-radiator to:
omit reradiating satellite-based navigation and positioning system signals at temporal locations other than temporal locations in one or more reradiation windows defined by the minimal time controlled reradiation schedule; and
reradiate satellite-based navigation and positioning system signals obtained from the first satellite-based navigation and positioning system receiver at temporal locations in the one or more reradiation windows defined by the minimal time controlled reradiation schedule to zero or more second satellite-based navigation and positioning system receivers.

11. The system of claim 10, wherein the one or more reradiation windows include:
at least one hot start reradiation window having an interval of one hour and having a duration of thirty second;
at least one warm start reradiation window having an interval of three and a half hours and having a duration of one minute; and
at least one cold start reradiation window having an interval of four thousand hours and having a duration of fifteen minutes.

12. The system of claim 10, wherein the one or more reradiation windows include:
at least one hot start reradiation window having an interval of one hour and having a duration of thirty seconds.

13. The system of claim 10, wherein the one or more reradiation windows include:
at least one warm start reradiation window having an interval of three and a half hours and having a duration of one minute.

14. The system of claim 10, wherein the one or more reradiation windows include:
at least one cold start reradiation window having an interval of four thousand hours and having a duration of fifteen minutes.

15. The system of claim 10, wherein the first satellite-based navigation and positioning system receiver has:
a first unobstructed signal path with respect to a first satellite-based navigation and positioning system satellite from the constellation of satellite-based navigation and positioning system satellites;
a second unobstructed signal path with respect to a second satellite-based navigation and positioning system satellite from the constellation of satellite-based navigation and positioning system satellites; and
a third unobstructed signal path with respect to a third satellite-based navigation and positioning system satellite from the constellation of satellite-based navigation and positioning system satellites.

16. The system of claim 10, wherein the first satellite-based navigation and positioning system receiver substantially continuously receives satellite-based navigation and positioning system signals transmitted by the constellation of satellite-based navigation and positioning system satellites.

17. The system of claim 10, wherein the first satellite-based navigation and positioning system receiver is mounted on an exterior surface of a satellite-based navigation and positioning system signal obstructing vehicle bay proximate to an exit of the satellite-based navigation and positioning system signal obstructing vehicle bay.

18. The system of claim 17, wherein:
the satellite-based navigation and positioning system re-radiator is mounted on an interior surface of the of the satellite-based navigation and positioning system signal obstructing vehicle bay such that satellite-based navigation and positioning system signals reradiated by the satellite-based navigation and positioning system re-radiator are directed away from the exit;
at least a portion of the satellite-based navigation and positioning system re-radiating antenna proximate to the exit is shielded; and
the zero or more second satellite-based navigation and positioning system receivers are spatially located within the vehicle bay such that the zero or more second satellite-based navigation and positioning system receivers are obstructed from otherwise receiving the satellite-based navigation and positioning system signals transmitted by the constellation of satellite-based navigation and positioning system satellites.

19. A non-transitory computer-readable storage medium, comprising executable instructions that, when executed by a processor, facilitate performance of operations, comprising:
operating a first satellite-based navigation and positioning system receiver having an unobstructed signal path with respect to at least one satellite-based navigation and positioning system satellite from a constellation of satellite-based navigation and positioning system satellites such that the first satellite-based navigation and positioning system receiver substantially continuously receives satellite-based navigation and positioning system signals transmitted by the constellation of satellite-based navigation and positioning system satellites, wherein the first satellite-based navigation and positioning system receiver is mounted on an exterior surface of a satellite-based navigation and positioning system signal obstructing vehicle bay proximate to an exit of the satellite-based navigation and positioning system signal obstructing vehicle bay; and
operating, in accordance with a minimal time controlled reradiation schedule, at least one satellite-based navigation and positioning system re-radiator operatively coupled with the first satellite-based navigation and positioning system receiver via a wireline electronic communication medium, wherein the at least one satellite-based navigation and positioning system re-radiator is mounted on an interior surface of the of the satellite-based navigation and positioning system signal obstructing vehicle bay such that satellite-based navigation and positioning system signals reradiated by the satellite-based navigation and positioning system re-radiator are directed away from the exit, wherein the satellite-based navigation and positioning system re-radiator includes a satellite-based navigation and positioning system re-radiating antenna, wherein at least a portion of the satellite-based navigation and positioning system re-radiating antenna proximate to the exit is shielded, wherein operating the at least one satellite-based navigation and positioning system re-radiator in accordance with the minimal time controlled reradiation schedule includes:
automatically preventing the at least one satellite-based navigation and positioning system re-radiator from reradiating satellite-based navigation and positioning system signals at temporal locations other than temporal locations in one or more reradiation windows defined by the minimal time controlled reradiation schedule; and
automatically operating the at least one satellite-based navigation and positioning system re-radiator to reradiate satellite-based navigation and positioning system signals obtained from the first satellite-based navigation and positioning system receiver at temporal locations in the one or more reradiation windows defined by the minimal time controlled reradiation schedule to zero or more second satellite-based navigation and positioning system receivers, wherein the zero or more second satellite-based navigation and positioning system receivers are spatially located within the vehicle bay such that the zero or more second satellite-based navigation and positioning system receivers are obstructed from otherwise receiving the satellite-based navigation and positioning system signals transmitted by the constellation of satellite-based navigation and positioning system satellites.

20. The non-transitory computer-readable storage medium of claim 19, wherein the one or more reradiation windows include:
at least one hot start reradiation window having an interval of one hour and having a duration of thirty second;
at least one warm start reradiation window having an interval of three and a half hours and having a duration of one minute; and
at least one cold start reradiation window having an interval of four thousand hours and having a duration of fifteen minutes.
